(19) United States
(12) Patent Application Publication
(10) Pub. No.: US 2026/0030962 A1
(43) Pub. Date: Jan. 29, 2026

(54) VIRTUAL TABLETOP GAME SYSTEM

(71) Applicant: Beijing Momo Information Technology Co., Ltd, Beijing (CN)

(72) Inventors: Maimaitiming Abudukadier, Beijing (CN); Jun Li, Beijing (CN); Li Zhang, Beijing (CN); Zhen Bao, Beijing (CN); Gaolong Lyu, Beijing (CN); Xudong Wang, Beijing (CN); Xufei Jin, Beijing (CN)

(21) Appl. No.: 19/246,428

(22) Filed: Jun. 23, 2025

(30) Foreign Application Priority Data
Jul. 24, 2024 (CN) 202410996497.0

(51) Int. Cl. G07F 17/32

(52) U.S. Cl. CPC G07F 17/3293; G07F 17/3211; G07F 17/3225; G07F 17/3276

(57) ABSTRACT

A virtual tabletop game system includes a tabletop game server and a plurality of tabletop game terminals. The tabletop game server is communicatively connected to each of the tabletop game terminals. The tabletop game server includes a tabletop game environment module configured to provide a three-dimensional (3D) tabletop game space, an avatar module configured to display a player avatar corresponding to each of the tabletop game terminals in the 3D tabletop game space, a video communication module configured to negotiate a tabletop game rule in the 3D tabletop game space and a tabletop game module configured to implement game interaction with each of the tabletop game terminals in the 3D tabletop game space. The virtual tabletop game system overcomes the limitation of physical props and venues in physical tabletop games, and enhances the authenticity and interactivity of communications.

### CROSS-REFERENCE TO RELATED APPLICATION

This application claims priority to Chinese Patent Application No. 202410996497.0, filed on Jul. 24, 2024, which is hereby incorporated by reference its entirety.

### TECHNICAL FIELD

The present disclosure relates to the technical field of virtual reality, and particularly to a virtual tabletop game system.

### BACKGROUND

The tabletop game refers to the game played on a table. There is a wide variety of tabletop games, covering many different themes, rules, and gameplay mechanics.

In the prior art, it has been possible to transform traditional tabletop games into digital versions. Digital tabletop games improve the convenience of tabletop gaming, allowing players to start a game anytime and anywhere via electronic devices without being restricted by physical props and venues. However, due to the wide variety of tabletop games, each traditional tabletop game requires the development of matching game rules when being converted into a digital version. Players need to log into different game interfaces for different types of digital tabletop games. Meanwhile, the digital tabletop games also lack the authentic face-to-face interaction communication and realism in traditional physical tabletop games. Therefore, how to propose a virtual tabletop game system which combines the convenience of the digital tabletop games with the authenticity of the physical tabletop games has become an important issue be solved urgently in this field.

### SUMMARY

Aiming at the problems in the prior art, embodiments of the present disclosure provide a virtual tabletop game system, which can at least partially solve the problems existed in the prior art.

The present disclosure provides a virtual tabletop game system, including a tabletop game server and a plurality of tabletop game terminals,
the tabletop game server is communicatively connected to each of the tabletop game terminals; and
the tabletop game server includes a tabletop game environment module, an avatar module, a video communication module and a tabletop game module; the tabletop game environment module is configured to provide a three-dimensional (3D) tabletop game space, the avatar module is configured to display a player avatar corresponding to each of the tabletop game terminals in the 3D tabletop game space, the video communication module is configured to negotiate a tabletop game rule in the 3D tabletop game space, and the tabletop game module is configured to implement game interaction with each of the tabletop game terminals in the 3D tabletop game space.

Further, the video communication module converts an audio provided by each of the tabletop game terminals into a 3D spatial audio during the negotiation of the tabletop game rule among the tabletop game terminals.

Further, the video communication module includes:
a calculation unit configured to calculate a position vector of a sound of each of the tabletop game players relative to every other tabletop game player;
a construction unit configured to construct a spatial transformation matrix for each of the tabletop game players relative to every other tabletop game player;
a conversion unit configured to obtain a stereo signal directed from each of the tabletop game players to every other tabletop game player, according to a sound signal of each of the tabletop game players and the spatial transformation matrix for sound of each of the tabletop game players relative to every other tabletop game player; and
a parsing unit configured to process the stereo signal directed from each of the tabletop game players to every other tabletop game player, and output a 3D spatial audio signal directed from each of the tabletop game players to every other tabletop game player.

Further, the tabletop game module includes a card distribution unit, a card shuffling unit and an information synchronization unit,
the card distribution unit is configured to distribute cards to the respective tabletop game players;
the card shuffling unit is configured to perform automatic card shuffling; and
the information synchronization unit is configured to synchronize game information.

Further, the game information includes card-draw information, card-play information, card-exchange information, card-conceal information, card-flip information, and card-withdraw information.

Further, the card distribution unit includes a card-deal subunit configured to automatically deal cards to the respective tabletop game players, and a card-draw subunit configured to implement card-draw by the respective tabletop game players.

Further, the 3D tabletop game space includes a game table and a plurality of seats therearound, and the player avatar corresponding to each of the tabletop game terminals is displayed at the corresponding seat.

Further, the virtual tabletop game system according to the embodiment of the present disclosure further including a virtual prop module configured to provide and display virtual props.

Further, a tabletop game includes a card-based tabletop game or a mahjong-based tabletop game.

Further, the tabletop game terminal utilizes an Apple Vision Pro® VR headset.

The virtual tabletop game system according to the embodiment of the present disclosure includes a tabletop game server and a plurality of tabletop game terminals, and the tabletop game server is communicatively connected to each of the tabletop game terminals; and the tabletop game server includes a tabletop game environment module, an avatar module, a video communication module and a tabletop game module; the tabletop game environment module is configured to provide a 3D tabletop game space, the avatar module is configured to display a player avatar corresponding to each of the tabletop game terminals in the 3D tabletop game space, the video communication module is configured to negotiate a tabletop game rule in the 3D tabletop game space, and the tabletop game module is configured to implement game interaction among all of the tabletop game terminals in the 3D tabletop game space. It enables playing tabletop games and negotiating the tabletop game rule in the 3D tabletop game space without pre-developing the game rule, which not only overcomes the limitations of physical props and venues in the traditional tabletop game, but also enhances the authenticity and interactivity of communications.

### BRIEF DESCRIPTION OF THE DRAWINGS

In order to more clearly illustrate the technical solutions in the embodiments of the present disclosure or in the prior art, the drawings to be used in the description of the embodiments or the prior art will be briefly introduced as follows. Obviously, the drawings concerned in the following description only illustrate some embodiments of the present disclosure, and those of ordinary skill in the art can obtain other drawings from these drawings without paying any inventive effects.

FIG. 1 illustrates an overall process diagram of a card game in the prior art.

FIG. 2 illustrates a structural diagram of a virtual tabletop game system according to a first embodiment of the present disclosure.

FIG. 3 illustrates a structural diagram of a video communication module according to a second embodiment of the present disclosure.

FIG. 4 illustrates a structural diagram of a virtual tabletop game system according to a third embodiment of the present disclosure.

FIG. 5 illustrates a structural diagram of a virtual tabletop game system according to a fourth embodiment of the present disclosure.

FIG. 6 illustrates a structural diagram of a virtual tabletop game system according to a fifth embodiment of the present disclosure.

### DESCRIPTION OF THE EMBODIMENTS

In order that the objectives, technical solutions and advantages of the embodiments of the present disclosure are clearer, the embodiments of the present disclosure will be further described in detail below with reference to the drawings. Here, the exemplary embodiments of the present disclosure and the descriptions thereof are used to illustrate the present disclosure, rather than being used as limitations thereto. It should be noted that the embodiments of the present disclosure and the features in the embodiments can be arbitrarily combined with each other without conflict. The obtaining, storage, use, processing, etc. of data in the technical solutions of the present disclosure comply with the relevant provisions of laws and regulations. Any user information in the embodiments of the present disclosure is obtained through legal and compliant means, and the obtaining, storage, use, processing, etc. of the user information are authorized and agreed by the customers.

In order to facilitate the understanding of the technical solutions of the present disclosure, the related contents of the technical solutions of the present disclosure will be firstly illustrated below.

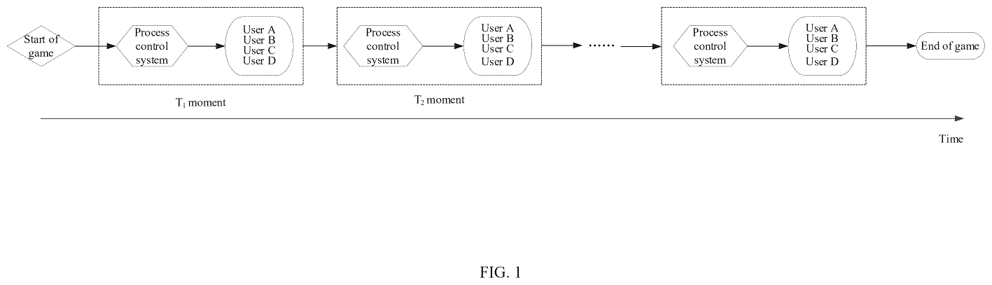

The existing digitalization solutions of card-based tabletop games are all designed for one specific gameplay mechanic, mainly involving the design of a process control system, which controls the game steps and the interactive logic with user terminals to complete a game session. For example, when four users, A, B, C and D, play a card game, a relationship between the overall process and the duration T of a card game session is illustrated in FIG. 1.

(1) When the card game starts, the process control system controls a game process.

(2) At T₁ moment, the process control system assigns users A, B, C and D to make corresponding interactive behaviors according to a preset game rule.

(3) At T₂ moment, the process control system assigns the users A, B, C, D to make new interactive behaviors after judgment and logical processing according to the interactive behaviors of the users at T₁ moment and the game rule.

(4) By analogy, the process of (3) is repeated from T₃ moment to Tₙ moment until the process control system determines that the game has ended.

Existing digital card-based tabletop games rely on the process control system, which is pre-developed and can only be customized for one specific card gameplay mechanic. The users can only play according to the game process set by the process control system, and are unable to take the initiative, thus losing the authentic face-to-face interaction communication and realism in traditional physical tabletop games.

The present disclosure aims to achieve spatial reconstruction while digitizing and virtualizing tabletop games in the traditional real world, highly simulating and restoring the physical characteristics of the card-based tabletop game and the interactive behaviors of the players to achieve a more immersive interactive experience, thereby realizing the sense restoration of presence and interactivity of a real-world. The technical solutions of the present disclosure can transcend the limitations of physical space while restoring the immersive feeling of the real world, thereby having broad application prospects and market potential.

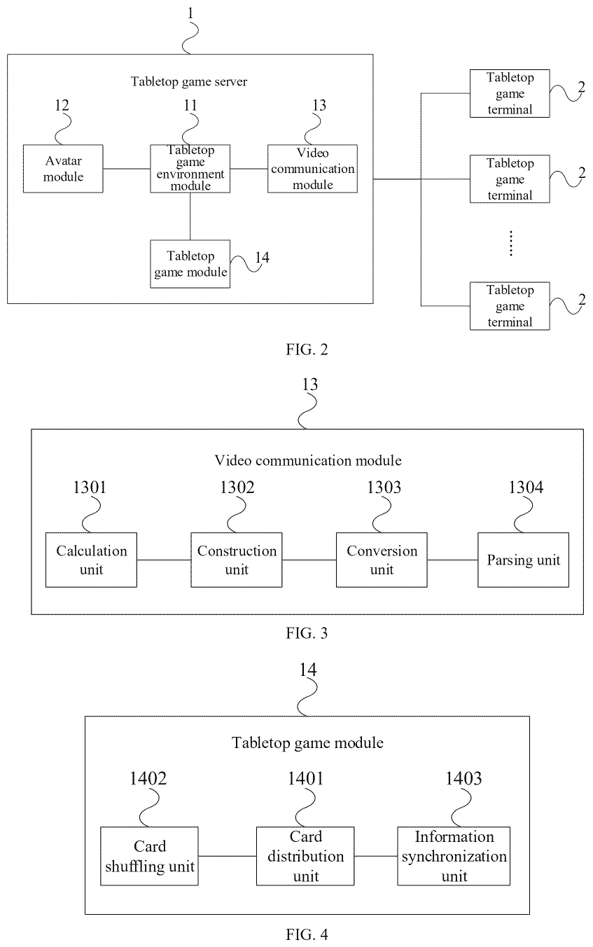

FIG. 2 illustrates a structural diagram of a virtual tabletop game system according to a first embodiment of the present disclosure. As illustrated in FIG. 2, the virtual tabletop game system according to the embodiment of the present disclosure includes a tabletop game server 1 and a plurality of tabletop game terminals 2.

In this embodiment, the tabletop game server 1 is communicatively connected to each of the tabletop game terminals 2;
the tabletop game server 1 includes a tabletop game environment module 11, an avatar module 12, a video communication module 13 and a tabletop game module 14; the tabletop game environment module 11 is configured to provide a three-dimensional (3D) tabletop game space, the avatar module 12 is configured to display a player avatar corresponding to each of the tabletop game terminals 2 in the 3D tabletop game space, the video communication module 13 is configured to negotiate a tabletop game rule in the 3D tabletop game space, and the tabletop game module 14 is configured to implement game interaction between all of the tabletop game terminals in the 3D tabletop game space.

Specifically, tabletop game players construct communication connections with the tabletop game server 1 via the tabletop game terminals 2, and then enter the 3D tabletop game space through the tabletop game environment module 11. Player avatars are capable of being displayed in the 3D tabletop game space, and each of the tabletop game players can engage in the tabletop game in the 3D tabletop game space. Before starting the tabletop game, the tabletop game players can negotiate the tabletop game rule via the video communication module 13. In the embodiments of the present disclosure, the gameplay mechanics of various table games do not need to be pre-configured, but negotiated by the table game players, so as to restore the authentic face-to-face interaction communication and realism in the traditional physical tabletop games. The video communication module 13 may also send the player avatar of each of the tabletop game players to the tabletop game terminals 2 of other tabletop game players. After negotiation and reaching a consensus, the tabletop game players can play in the 3D tabletop game space. The tabletop game module 14 can realize game interactions among the tabletop game terminals 2, synchronize information generated in the 3D tabletop game space to each of the tabletop game terminals 2, and synchronize information obtained from each of the tabletop game terminals 2 to the 3D tabletop game space. The tabletop game server 1 may be configured as a single server or a server cluster depending on actual needs, which is not limited in the embodiments of the present disclosure. The tabletop game terminal 2 includes, but is not limited to, an Apple Vision Pro® VR headset (Apple VR headset).

The player avatar is pre-constructed, and may be a personal avatar, a 3D personal avatar or a stylized personal avatar, which may be set by the users depending on actual situations and is not limited in the embodiments of the present disclosure. The personal avatar (Persona) is an image generated based on a camera of Vision Pro® VR headset, which achieves drivable virtual emoticons through technologies such as facial key point detection, and can authentically represent the occurrence of a user in a basic space. The 3D personal avatar is a 3D model produced based on a physically based rendering (PBR) process, enabling the creation of a personalized personal avatar. Based on facial recognition and facial key point detection, a stylized personal avatar based on the user's face is generated through an AI algorithm, which also enables expression driving.

The virtual tabletop game system according to the embodiment of the present disclosure includes a tabletop game server and a plurality of tabletop game terminals, and the tabletop game server is communicatively connected to each of the tabletop game terminals; the tabletop game server includes a tabletop game environment module, an avatar module, a video communication module and a tabletop game module; the tabletop game environment module is configured to provide a 3D tabletop game space, the avatar module is configured to display a player avatar corresponding to each of the tabletop game terminals in the 3D tabletop game space, the video communication module is configured to negotiate a tabletop game rule in the 3D tabletop game space, and the tabletop game module is configured to implement game interaction with each of the tabletop game terminals in the 3D tabletop game space. It implements playing tabletop games and negotiating the tabletop game rule in the 3D tabletop game space without pre-developing the game rule, which not only overcomes the limitations of physical props and venues in the traditional tabletop game, but also enhances the authenticity and interactivity of communications, thereby facilitating the playing of various tabletop games, and improving the players' experience.

On the basis of the above embodiments, further, the video communication module 13 converts an audio provided by each of the tabletop game terminals 2 into a 3D spatial audio during the negotiation of the tabletop game rule among the tabletop game terminals 2.

Specifically, during the negotiation of the tabletop game rule, each of the tabletop game players may express his opinions through the tabletop game terminal 2, and the tabletop game terminal 2 may send the opinions of the tabletop game players to the tabletop game server 1. The video communication module 13 may convert the opinions of the tabletop game players into 3D spatial audios to be played in the 3D tabletop game space, so that each of the tabletop game players can hear the 3D spatial audios of other tabletop game players through the worn tabletop game terminal 2, and feel the directions and the distances of the sound sources. The immersive experience of the tabletop game players in the 3D tabletop game space can be enhanced through the 3D spatial audios.

FIG. 3 illustrates a structural diagram of a video communication module according to a second embodiment of the present disclosure. As illustrated in FIG. 3, on the basis of the above embodiments, further, the video communication module 13 includes a calculation unit 1301, a construction unit 1302, a conversion unit 1303, and a parsing unit 1304,

In this embodiment, the calculation unit 1301 is configured to calculate a position vector of a sound of each of the tabletop game players relative to every other tabletop game player; the construction unit 1302 is configured to construct a spatial transformation matrix for each of the tabletop game players relative to every other tabletop game player; the conversion unit 1303 is configured to obtain a stereo signal directed from each of the tabletop game players to every other tabletop game player, according to a sound signal of each of the tabletop game players and the spatial transformation matrix for sound of each of the tabletop game players relative to every other tabletop game player; and the parsing unit 1304 is configured to process the stereo signal directed from each of the tabletop game players to every other tabletop game player, and output a 3D spatial audio signal directed from each of the tabletop game players to every other tabletop game player.

Specifically, for each of the tabletop game players, the calculation unit 1301 can calculate the position vector of the sound of each of the tabletop game players relative to every other tabletop game player. Spatial coordinates of tabletop game players A, B, C and D in the 3D tabletop game space are respectively supposed as follows: the tabletop game player A: (x_A, y_A, z_A); the tabletop game player B: (x_B, y_B, z_B); the tabletop game player C=(x_C, y_C, z_C); and the tabletop game player D: (x_D, y_D, z_D). Then, the position vector of the tabletop game player A relative to the tabletop game player B is v_AB=(x_B−x_A, y_B−y_A, z_B−z_A), the position vector of the tabletop game player A relative to the tabletop game player C is v_AC=(x_C−x_A, y_C−y_A, z_C−z_A), and the position vector of the tabletop game player A relative to the tabletop game player D is v_AD=(x_D−x_A, y_D−y_A, z_D−z_A). Similarly, the position vector of the tabletop game player B relative to the tabletop game player A is v_BA=(x_A−x_B, y_A−y_B, z_A−z_B), the position vector of the tabletop game player B relative to the tabletop game player C is v_BC=(x_C−x_B, y_C−y_B, z_C−z_B), and the position vector of the tabletop game player B relative to the tabletop game player D is v_BD=(x_D−x_B, y_D y_B, z_D−z_B). The position vector of the tabletop game player C relative to the tabletop game player A is v_CA=(x_A−x_C, y_A−y_C, z_A−z_C), the position vector of the tabletop game player C relative to the tabletop game player B is v_CB=(x_B−x_C, y_B−y_C, z_B−z_C), and the position vector of the tabletop game player C relative to the tabletop game player D is v_CD=(x_D−x_C, y_D−y_C, z_D−z_C). The position vector of the tabletop game player D relative to the tabletop game player A is v_DA=(x_A−x_D, y_A−y_D, z_A−z_D), the position vector of the tabletop game player D relative to the tabletop game player B is v_DB=(x_B−x_D, y_B−y_D, z_B−z_D), and the position vector of the tabletop game player D relative to the tabletop game player C is v_DC=(x_C−x_D, y_C−y_D, z_C−z_D). In this embodiment, each of the tabletop game players will have an initial spatial coordinate after logging into the 3D tabletop game space.

For each of the tabletop game players, the construction unit 1302 may construct the spatial transformation matrix for each of the tabletop game players relative to every other tabletop game player. The spatial transformation matrix is used to transforms the sound signal of a tabletop game player from his own spatial coordinate system into a spatial coordinate system of another tabletop game player. The spatial transformation matrix for the tabletop game player A relative to the tabletop game player B is

$${R}_{AB} = [ \begin{matrix}n\_AB & u\_AB & v\_AB \\ u\_AB & n\_AB & w\_AB \\ v\_AB & w\_AB & n\_AB\end{matrix} ] ,$$

where n_AB, u_AB, v_AB, and w_AB are a head orientation vector, a head up vector, a head right vector, and a head normal vector pointing towards the tabletop game player B, respectively. n_AB=(v_AB/∥v_AB∥), u_AB=cross (n_AB, [0, 1, 0]), v_AB=cross (n_AB, u_AB), and w_AB=−n_AB. Similarly, the spatial transformation matrix for the tabletop game player A relative to the tabletop game player C may be obtained as

$${R}_{AC} = [ \begin{matrix}n\_AC & u\_AC & v\_AC \\ u\_AC & n\_AC & w\_AC \\ v\_AC & w\_AC & n\_AC\end{matrix} ] ,$$

and the spatial transformation matrix for the tabletop game player A relative to the tabletop game player D may be obtained as

$${R}_{AD} = [ \begin{matrix}n\_AD & u\_A & v\_AC \\ u\_AD & n\_AD & w\_AC \\ v\_AD & w\_AD & n\_AC\end{matrix} ] .$$

The conversion unit 1303 may convert the sound signal of each of the tabletop game players into a stereo signal directed from the tabletop game player to every other tabletop game player. The stereo signal directed from the tabletop game player A to the tabletop game player B is s_AB=R_{AB}·audio_A; the stereo signal directed from the tabletop game player A to the tabletop game player C is s_AC=R_{AC}·audio_A; the stereo signal directed from the tabletop game player A to the tabletop game player D is s_AD=R_{AD}·audio_A; where audio_A is the sound signal of the tabletop game player A.

A head-related transfer function (HRTF) describes the spectral changes that occur as the sound propagates from a sound source to a human ear. The parsing unit 1304 applies an HRTF filter to each of the stereo signals to simulate the reflection and the diffraction of the sound around a head and an auricle, thereby enabling the tabletop game player to obtain a more realistic auditory experience. The parsing unit 1304 performs HRTF filtering on a stereo signal s_AB directed from the tabletop game player A to the tabletop game player B, and obtains a 3D spatial audio signal o_AB=HRTF_B(s_AB) directed from the tabletop game player A to the tabletop game player B; the parsing unit 1304 performs HRTF filtering on a stereo signal s_AC directed from the tabletop game player A to the tabletop game player C, and obtains a 3D spatial audio signal o_AC=HRTF_C (s_AC) directed from the tabletop game player A to the tabletop game player C; the parsing unit 1304 performs HRTF filtering on a stereo signal s_AD directed from the tabletop game player A to the tabletop game player D, and obtains a 3D spatial audio signal o_AD=HRTF_D (s_AD) directed from the tabletop game player A to the tabletop game player D. In this embodiment, HRTF_B, HRTF_C, and HRTF_D are the HRTF filters for the tabletop game players B, C and D, respectively.

FIG. 4 illustrates a structural diagram of a virtual tabletop game system according to a third embodiment of the present disclosure. As illustrated in FIG. 4, on the basis of the above embodiments, further, the tabletop game module 14 includes a card distribution unit 1401, a card shuffling unit 1402 and an information synchronization unit 1403.

In this embodiment, the card distribution unit 1401 is configured to distribute cards to the respective tabletop game players;
the card shuffling unit 1402 is configured to perform automatic card shuffling; and
the information synchronization unit 1403 is configured to synchronize game information.

Specifically, the card distribution unit 1401 may either deal cards automatically or allow the manual card-draw by the tabletop game players. The automatic card dealing by the card distribution unit 1401 is to automatically distribute the shuffled cards to the tabletop game players according to predefined quantities. For example, suppose there are four tabletop game players A, B, C and D using a deck of cards, the number of reserved bottom cards is L, and the number of cards dealt to the respective tabletop game players is F. The card distribution unit 1401 draws L cards from the bottom of the shuffled cards as the reserved bottom cards, and deals cards sequentially to the four tabletop game players A, B, C and D clockwise from the top of the shuffled cards, and the respective tabletop game players receives one card per round, and the card dealing is conducted for a total of F rounds. After the card dealing is completed, the four tabletop game players A, B, C and D can play cards in the 3D tabletop game space according to the pre-determined gameplay rule.

The card shuffling unit 1402 is configured to perform automatic card shuffling. Before automatically shuffling cards, the parameters of the card shuffling unit 1402 need to be initialized, and the parameters to be initialized may be set depending on actual needs and are not limited in the embodiments of the present disclosure. For example, the parameters to be initialized for the cards include, but are not limited to, the number of card decks N, the number of reserved bottom cards, and the cards to be removed. The card shuffling unit 1402 determines a total number of cards to be 54N according to N decks of cards. When the tabletop game players select to remove

M cards, the card shuffling unit 1402 removes the M cards selected by the tabletop game players from the 54N cards. When the tabletop game players select not to reserve any bottom card, the number of remaining cards is V=54N−M. The card shuffling unit 1402 may shuffle the V cards using a Fisher-Yates shuffle algorithm.

The information synchronization unit 1403 is configured to synchronize the game information. For example, the information synchronization unit 1403 may synchronize information of card-draw, card-play, card-exchange, card-conceal, card-flip, and card-withdraw, and the like from each of the tabletop game terminals 2 to other tabletop game terminals. The information synchronization unit 1403 may synchronize game-related information displayed in the 3D tabletop game space to each of the tabletop game terminals 2. The card-draw means directly taking one card from the top of the undealt deck; and when more cards need to be drawn, the card-draw may be operated consecutively for multiple times, in which only one card is drawn each time. The card-play means that a tabletop game player discards a held card and reveals them to other tabletop game players, in which one or more cards may be played each time. The card-exchange means that a tabletop game player discards held cards and reveals them to other tabletop game players, and any one of other tabletop game players may take the discarded card, and one or more cards may be exchanged each time. The card-conceal means that a tabletop game player discards held cards without revealing them to other tabletop game players, and keeping the card face remaining invisible, and one or more cards may be concealed each time. The card-flip means turning over the concealed cards, which specifically may be changing a card face from visible to invisible or from invisible to visible, and one or more cards may be flipped each time. The card-withdrawal means that when hoping to adjust or cancel the played card after discovering a problem or a mistake of the played card, the tabletop game player needs to perform a withdrawal operation on the discarded card, and after the withdrawal operation is performed, all the cards played for the latest time will be put back into the held cards, and the withdrawal operation may be performed for one or more times. The information synchronization unit 1403 may send the information of the basic operations such as card-draw, card-play, card-exchange, card-conceal, card-flip, and card-withdraw, and the like to the tabletop game terminal 2.

For example, when the tabletop game players A, B, C and D are engaged in a virtual tabletop game and the tabletop game player A wants to play the Heart A, the process of playing the Heart A in the 3D tabletop game space is as follows.

The tabletop game player A selects to play the Heart A via the tabletop game terminal 2, and the tabletop game terminal 2 sends the information of the selection operation of the tabletop game player A to the tabletop game server 1.

The tabletop game space module 11 displays the Heart A in the 3D tabletop game space. The information synchronization unit 1403 sends a message “the tabletop game player A plays the Heart A” to the tabletop game terminal 2 of the tabletop game player B. The tabletop game terminal 2 updates a local card-playing state of the tabletop game player A, and after a successful update, returns a message indicating that the card-playing state has been successfully updated to the information synchronization unit 1403.

The information synchronization unit 1403 sends a message “the tabletop game player A plays the Heart A” to the tabletop game terminal 2 of the tabletop game player C, and the tabletop game terminal 2 updates a local card-playing state of the tabletop game player A, and after a successful update, returns a message indicating that the card-playing state has been successfully updated to the information synchronization unit 1403.

The information synchronization unit 1403 sends a message “the tabletop game player A plays the Heart A” to the tabletop game terminal 2 of the tabletop game player D, and the tabletop game terminal 2 updates a local card-playing state of the tabletop game player A, and after a successful update, returns a message indicating that the card-playing state has been successfully updated to the information synchronization unit 1403.

On the basis of the above embodiments, further, the game information includes card-draw information, card-play information, card-exchange information, card-conceal information, card-flip information, and card-withdraw information.

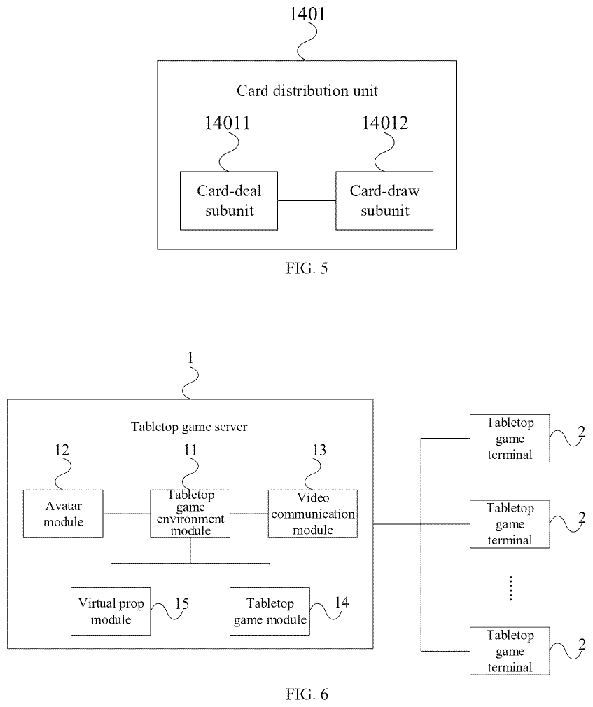

FIG. 5 illustrates a structural diagram of a virtual tabletop game system provided by the fourth embodiment of the present disclosure. As illustrated in FIG. 5, on the basis of the above embodiments, further, the card distribution unit 1401 includes a card-deal subunit 14011 configured to automatically deal cards to the respective tabletop game players, and a card-draw subunit 14012 configured to implement card-draw by the respective tabletop game players.

The card-draw subunit 14012 may detect a card-draw operation of the tabletop game player via the tabletop game terminal 2 in the 3D tabletop game space. The card-draw subunit 14012 distributes cards to the corresponding tabletop game player in response to the card-draw operation, in which the card-draw operation is set depending on actual needs, which is not limited in the embodiments of the present disclosure.

On the basis of the above embodiments, further, the 3D tabletop game space includes a game table and a plurality of seats therearound, and the player avatar corresponding to each of the tabletop game terminals is displayed at the corresponding seat.

Specifically, in order to restore the scenario of the physical tabletop game, the 3D tabletop game space may be provided with a game table and a plurality of seats. After entering the 3D tabletop game space via the tabletop game terminal 2, the tabletop game player may be assigned with one seat where the player avatar of the tabletop game player is displayed. Game props such as virtual cards and virtual mahjong may be placed on the game seat, and the cards played with each of the game props in the 3D tabletop game space may also be displayed on the game seat. The plurality of seats are disposed around the game table, and the specific number of the seats is set depending on actual needs, which is not limited in the embodiments of the present disclosure. It is understandable that when the seats are full of players, any tabletop game player entering this 3D tabletop game space thereafter may act as spectators.

FIG. 6 illustrates a structural diagram of a virtual tabletop game system according to a fifth embodiment of the present disclosure. As illustrated in FIG. 6, on the basis of the above embodiments, further, the virtual tabletop game system according to the embodiment of the present disclosure includes a virtual prop module 15 configured to provide and display virtual props, including but not limited to virtual gifts, virtual decorative items, virtual emoticons, etc., which are employed for the interaction between the tabletop game players.

On the basis of the above embodiments, further, the tabletop game includes a card game and a mahjong-based game. It should be noted that the embodiments of the present disclosure provide card props and mahjong props without a specific game rule.

On the basis of the above embodiments, further, the tabletop game terminal 2 utilizes an Apple Vision Pro® VR headset, which can provide excellent visual and auditory experiences, thereby bringing about a high-quality virtual reality experience.

The card game is taken as an example below to describe the application process of the virtual tabletop game system according to the embodiments of the present disclosure.

Tabletop game players X, Y and Z meet to play poker in a 3D personal space of the tabletop game player X. Each of the tabletop game players X, Y and Z wears an Apple Vision Pro® VR headset, accesses a server where a 3D tabletop game space of the tabletop game player X is located, and then logs into the 3D tabletop game space. The server where the 3D tabletop game space of the tabletop game player X is located serves as a tabletop game server.

A game table and a plurality of seats are placed in the 3D tabletop game space of the tabletop game player X. After the tabletop game players X, Y and Z enter the 3D tabletop game space of the tabletop game player X, the tabletop game space module assigns one seat to each of the tabletop game players X, Y and Z. The avatar module can obtain and display the player avatar of each of the tabletop game players X, Y and Z on their respective seats. The tabletop game players X, Y and Z send their respective voice messages to the tabletop game server through Apple Vision Pro® VR headset. The video communication module converts the voice message of the respective tabletop game players into a 3D spatial audio signal, and sends the 3D spatial audio signal to other tabletop game players through the Apple Vision Pro® VR headset, so that the tabletop game players X, Y and Z can negotiate the specific card gameplay mechanic. The tabletop game players X, Y and Z may negotiate and decide a plurality of card gameplay mechanics, one of which is adopted each time, and the card gameplay mechanics can be continuously changed in the 3D tabletop game space.

Before starting a specific card game, one of the tabletop game players selects the number of decks of cards (i.e., how many decks will be employed) via the Apple Vision Pro® VR headset, based on the gameplay mechanic agreed upon through negotiation. When it is necessary to reserve the bottom cards, the number of bottom cards to be reserved is selected, and when it is necessary to remove some cards, the cards to be removed is selected. It is also possible to select automatic card dealing or manual card-draw, and in the example of the present disclosure, automatic card dealing is selected. After selection, it waits for the respective tabletop game players to confirm the start of the game via their respective Apple Vision Pro® VR headsets.

After the tabletop game server detects that the tabletop game players X, Y and Z have each confirmed the start of the game via their respective Apple Vision Pro® VR headsets, the card shuffling unit of the tabletop game module shuffles cards, and then the card distribution unit automatically deals cards to the tabletop game players X, Y and Z. Through the information synchronization unit, the cards of the tabletop game players X, Y and Z are synchronized to their respective Apple Vision Pro® VR headsets for displaying.

Based on the gameplay mechanic agreed upon through negotiation, the tabletop game players X, Y and Z perform card game operations, including but not limited to a card-draw operation, a card-play operation, a card-exchange operation, a card-conceal operation, a card-flip operation, a card-withdraw operation, etc. In response to various card game operations, the information synchronization unit synchronizes the latest card information to the Apple Vision Pro® VR headsets of the tabletop game players X, Y and Z for displaying. When a round of the game is ended, the tabletop game players X, Y and Z may select to continue, restart or end the game. When the game is to be continued, a new round of the same game will be started. When the game is to be restarted, it is possible to reselect the number of decks of playing cards, the number of bottom cards to be reserved, and the cards to be removed. When the game is to be ended, the card-based tabletop game will be exited. It is understandable that when the number of decks of playing card, the number of bottom cards to be reserved, and the cards to be removed remain unchanged, and only the gameplay mechanic changes, the tabletop game players X, Y and Z may select to continue the game. In this case, it is only necessary to change the gameplay mechanic through the video communication module, thereby facilitating the switching of the gameplay mechanic by the players. During the game, the tabletop game players X, Y and Z can still conduct communications and interactions through the video communication module, which is similar to the situation where the physical card game are placed around the table.

The virtual tabletop game system provided in the present disclosure enables the players to experience the communication of the specific card game rule and the interaction logic by means of oral chatting while gathering around a table, just like in physical tabletop games, thereby obtaining great fun from card-playing interactions. Meanwhile, unlike the physical tabletop games, it does not need a physical space or require the players to gather together, thereby overcoming the limitations of space and distance. The virtual tabletop game system offers flexible gameplay mechanics and good interactivity similar to those in the real world, without requiring tabletop game venues and props, thereby enabling convenient tabletop gaming across space and distance, and bringing a more immersive gaming experience to the players.

In the description of the present disclosure, the description of reference terms “an embodiment”, “a specific embodiment”, “some embodiments”, “for example”, “an example”, “a specific example” or “some examples” and the like mean that the specific features, structures, materials, or characteristics described in conjunction with the embodiment(s) or example(s) are included in at least one embodiment or example of the present disclosure. In the present disclosure, the schematic expressions of the above terms do not necessarily aim at the same embodiment or example. Moreover, the specific features, structures, materials, or characteristics described may be combined in any one or more embodiments or examples in a suitable manner.

The specific embodiments described above further illustrate the objectives, technical solutions and advantageous effects of the present disclosure in detail. It should be understood that those described above are just specific embodiments of the present disclosure, rather than limitations thereto. Any modification, equivalent substitution, improvement, etc. made within the spirit and principle of the present disclosure should be included in the protection scope of the present disclosure.

What is claimed is:

1. A virtual tabletop game system, comprising a tabletop game server and a plurality of tabletop game terminals, wherein
the tabletop game server is communicatively connected to each of the tabletop game terminals; and
the tabletop game server comprises a tabletop game environment module, an avatar module, a video communication module and a tabletop game module; the tabletop game environment module is configured to provide a three-dimensional (3D) tabletop game space, the avatar module is configured to display a player avatar corresponding to each of the tabletop game terminals in the 3D tabletop game space, the video communication module is configured to negotiate a tabletop game rule in the 3D tabletop game space, and the tabletop game module is configured to implement game interaction with each of the tabletop game terminals in the 3D tabletop game space.

2. The virtual tabletop game system according to claim 1, wherein the video communication module converts an audio provided by each of the tabletop game terminals into a 3D spatial audio during the negotiation of the tabletop game rule among the tabletop game terminals.

3. The virtual tabletop game system according to claim 2, wherein the video communication module comprises:
a calculation unit configured to calculate a position vector of a sound of each of the tabletop game players relative to every other tabletop game player;
a construction unit configured to construct a spatial transformation matrix for each of the tabletop game players relative to every other tabletop game player;
a conversion unit configured to obtain a stereo signal directed from each of the tabletop game players to every other tabletop game player, according to a sound signal of each of the tabletop game players and the spatial transformation matrix for each of the tabletop game players relative to every other tabletop game player; and
a parsing unit configured to process the stereo signal directed from each of the tabletop game players to every other tabletop game player, and output a 3D spatial audio signal directed from each of the tabletop game players to every other tabletop game player.

4. The virtual tabletop game system according to claim 1, wherein the tabletop game module comprises a card distribution unit, a card shuffling unit and an information synchronization unit, wherein
the card distribution unit is configured to distribute cards to the respective tabletop game players;
the card shuffling unit is configured to perform automatic card shuffling; and
the information synchronization unit is configured to synchronize game information.

5. The virtual tabletop game system according to claim 4, wherein the game information comprises card-draw information, card-play information, card-exchange information, card-conceal information, card-flip information, and card-withdraw information.

6. The virtual tabletop game system according to claim 4, wherein the card distribution unit comprises a card-deal subunit configured to automatically deal cards to the respective tabletop game players, and a card-draw subunit configured to implement card-draw by the respective tabletop game players.

7. The virtual tabletop game system according to claim 1, wherein the 3D tabletop game space comprises a game table and a plurality of seats therearound, and the player avatar corresponding to each of the tabletop game terminals is displayed at the corresponding seat.

8. The virtual tabletop game system according to claim 1, further comprising a virtual prop module configured to provide and display virtual props.

9. The virtual tabletop game system according to claim 1, wherein a tabletop game comprises a card-based tabletop game or a mahjong-based tabletop game.

10. The virtual tabletop game system according to claim 1, wherein the tabletop game terminal utilizes an Apple Vision Pro® VR headset.

11. The virtual tabletop game system according to claim 2, wherein the tabletop game terminal utilizes an Apple Vision Pro® VR headset.

12. The virtual tabletop game system according to claim 3, wherein the tabletop game terminal utilizes an Apple Vision Pro® VR headset.

13. The virtual tabletop game system according to claim 4, wherein the tabletop game terminal utilizes an Apple Vision Pro® VR headset.

14. The virtual tabletop game system according to claim 5, wherein the tabletop game terminal utilizes an Apple Vision Pro® VR headset.

15. The virtual tabletop game system according to claim 6, wherein the tabletop game terminal utilizes an Apple Vision Pro VR headset.

16. The virtual tabletop game system according to claim 7, wherein the tabletop game terminal utilizes an Apple Vision Pro® VR headset.

17. The virtual tabletop game system according to claim 8, wherein the tabletop game terminal utilizes an Apple Vision Pro® VR headset.

18. The virtual tabletop game system according to claim 9, wherein the tabletop game terminal utilizes an Apple Vision Pro® VR headset.

19. The virtual tabletop game system according to claim 10, wherein the tabletop game terminal utilizes an Apple Vision Pro® VR headset.
